(19) United States
(12) Patent Application Publication
(10) Pub. No.: US 2014/0257927 A1
(43) Pub. Date: Sep. 11, 2014

(54) COMPUTER SYSTEM FOR PROCESSING DATA ON RETURNED GOODS

(71) Applicant: Clear Returns Limited, Glasgow (GB)

(72) Inventors: Victoria Brock, Renfrew (GB); Stephen Budd, Renfrew (GB); Shaylon Stolk, Glasgow (GB); Pawel Kublas, Edinburgh (GB)

(73) Assignee: Clear Returns Limited, Glasgow (GB)

(21) Appl. No.: 14/204,643

(22) Filed: Mar. 11, 2014

(30) Foreign Application Priority Data
Mar. 11, 2013 (GB) 1304277.5

(51) Int. Cl. G06Q 30/00; G06Q 30/02

(52) U.S. Cl. CPC G06Q 30/016; G06Q 30/0202
USPC 705/7.31; 705/304; 705/26.7

(57) ABSTRACT

One aspect provides a computer system for processing data on returned products, by receiving returns data on purchased products returned for a refund; and determining predicted return data for a product sold in the future based on the returns data for the product purchased in the past. Another aspect provides a computer system for receiving customer selection data for a product that the customer proposes to one of purchase and refund, the customer selection data including data identifying the customer and the product; accessing returns data using at least one of the data identifying the customer and the data identifying the product, the returns data indicating at least one of a customer's propensity to return products and a propensity of the product to be returned; and generating a customer interface dependent upon on the returns data for one of the proposed purchase and the proposed refund.

### PRIORITY APPLICATION

This application claims the benefit of priority under 35 U.S.C. 119 to United Kingdom Application No 1304277.4, filed on 11 Mar. 2013; which application is incorporated herein by reference in its entirety.

### FIELD OF THE INVENTION

The present invention relates to a computer system for processing returned goods.

### BACKGROUND INFORMATION

In e-commerce and other forms of distance selling, it is necessary to have a returns system to deal with products, which are of the wrong size or are faulty. Most merchants are also willing to accept returns simply on the basis that the customer does not like the product.

Returns of this nature, which could be characterized as “legitimate” returns, impose considerable administrative and logistics costs. There is a need for systems that can enable the merchant to manage returns and improve the ordering process in a manner to reduce the incidence of returns and/or generate additional or replacement sales.

In addition, however, the returns procedure is open to a number of fraudulent or abusive practices.

One example is “wear and return” where the customer orders an item, wears it once, and returns it for refund. This most often happens with occasion wear. The item may be returned as “wrong size” or as “faulty” and in the latter case may have been damaged by the client, for example by opening a seam.

In another example, the customer purchases an item in order to access a discount on other purchases, and then returns it, or the customer repeatedly buys and then returns the same product to obtain use of the product over a period without payment.

### SUMMARY OF THE INVENTION

One aspect provides a computer system for processing data on returned products, the system comprising a program memory storing program code; and a processor for implementing the program code stored in the program memory; wherein the program code comprises code for controlling the processor to receive returns data on purchased products returned for a refund; and code for controlling the processor to determine predicted return data for a product sold in the future based on the returns data for the product purchased in the past.

Another aspect provides a computer system for processing data on returned products, the system comprising a program memory storing program code; and a processor for implementing the program code stored in the program memory; wherein the program code comprises: code for controlling the processor to receive returns data on purchased products returned for a refund; code for controlling the processor to compare the returns data with reference returns data for the products; and code for controlling the processor to generate an alert for a merchant of a product when the result of the comparison indicates a difference above a threshold difference.

Another aspect provides a computer system for processing data on returned products, the system comprising a program memory storing program code; and a processor for implementing the program code stored in the program memory; wherein the program code comprises code for controlling the processor to receive returns data on purchased products returned for a refund, the returns data includes data on the reasons for the return of the product; code for controlling the processor to determine recommended action to be taken by the merchant to reduce future returns for a product based on the data on the reason for return of the products; and code for controlling the processor to generate an output of the recommended action for display to the merchant.

Another aspect provides a computer system comprising a program memory storing program code; and a processor for implementing the program code stored in the program memory; wherein the program code comprises: code for controlling the processor to receive customer selection data for a product that the customer proposes to one of purchase and refund, the customer selection data including data identifying the customer and the product; code for controlling the processor to access returns data using at least one of the data identifying the customer and the data identifying the product, the returns data indicating at least one of a customer's propensity to return products and a propensity of the product to be returned; and code for controlling the processor to generate a customer interface dependent upon on the returns data for one of the proposed purchase and the proposed refund.

Another aspect provides an ecommerce system comprising a program memory storing program code; and a processor for implementing the program code stored in the program memory; wherein the program code comprises: code for controlling the processor to receive customer selection data for a product that the customer proposes to refund, the customer selection data including data identifying the product; code for controlling the processor to access returns data using the data identifying the product, the returns data indicating a propensity of the product to be returned; code for controlling the processor to identify alternative products using the returns data for the product and returns data for the alternative products; and code for controlling the processor to generate exchange data identifying the alternative products to be offered to the customer in exchange for the product.

### BRIEF DESCRIPTION OF THE DRAWINGS

FIG. 1 is a schematic diagram illustrating a computer system according to one embodiment;

FIG. 2 is a flow diagram illustrating the process according to one embodiment;

FIG. 3 is a flow diagram illustrating the data acquisition and preprocessing process according to one embodiment;

FIG. 4 is a flow diagram illustrating the returns prediction process according to one embodiment;

FIG. 5 is a flow diagram illustrating the alert generation process according to one embodiment;

FIG. 6 is a flow diagram illustrating the alert ranking process according to one embodiment;

FIG. 7 is a flow diagram illustrating the merchant action recommendation process according to one embodiment;

FIG. 8 is a flow diagram illustrating the customer score process according to one embodiment;

FIG. 9 is a flow diagram illustrating the product return rate calculation process according to one embodiment;

FIG. 10 is a flow diagram illustrating the process for using the customer's score to modify the user interface at the merchant according to one embodiment;

FIG. 11 is a flow diagram illustrating the process to encourage customers to exchange the products rather than return them according to one embodiment; and

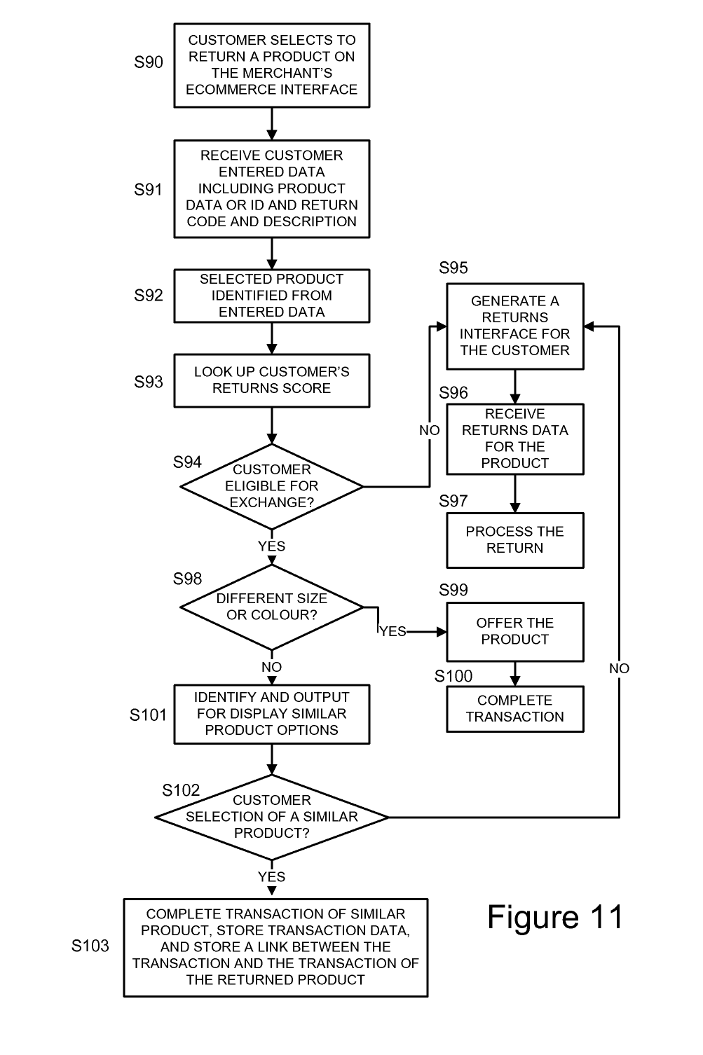

FIG. 12 is a flow diagram illustrating the process to identify similar products according to one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides a method and system that uses data on return transactions for purchased products to provide an enhanced ecommerce environment, which can for example assist merchants to reduce the likelihood of returns, manage returns, identify and reduce abuse of the returns service, reduce the costs of the returns service, and explore retail opportunities in the returns process by encouraging conversion of the return into an exchange. In one embodiment, the customers are each attributed with a returns score which is an indicator of their propensity to return products, and can be used by merchants as a means of measuring the customers trustworthiness in entering into transactions with them. The returns score for customers enables a merchant to modify the way it interacts with the customer through its user interface. The user interface can adapt to the returns score for customers to change the terms on which the merchant does business with the customers.

A returns processing system can be provided connected over a network to merchants to provide the service to many merchants. In one embodiment, a merchant can provide its own returns processing system providing an in-house returns processing capability.

To provide an enhanced ecommerce system in which the likelihood of returns for products purchased is reduced, a merchant's computer system can work in conjunction with a separate returns processing system.

Specific embodiments will now be described with reference to the drawings.

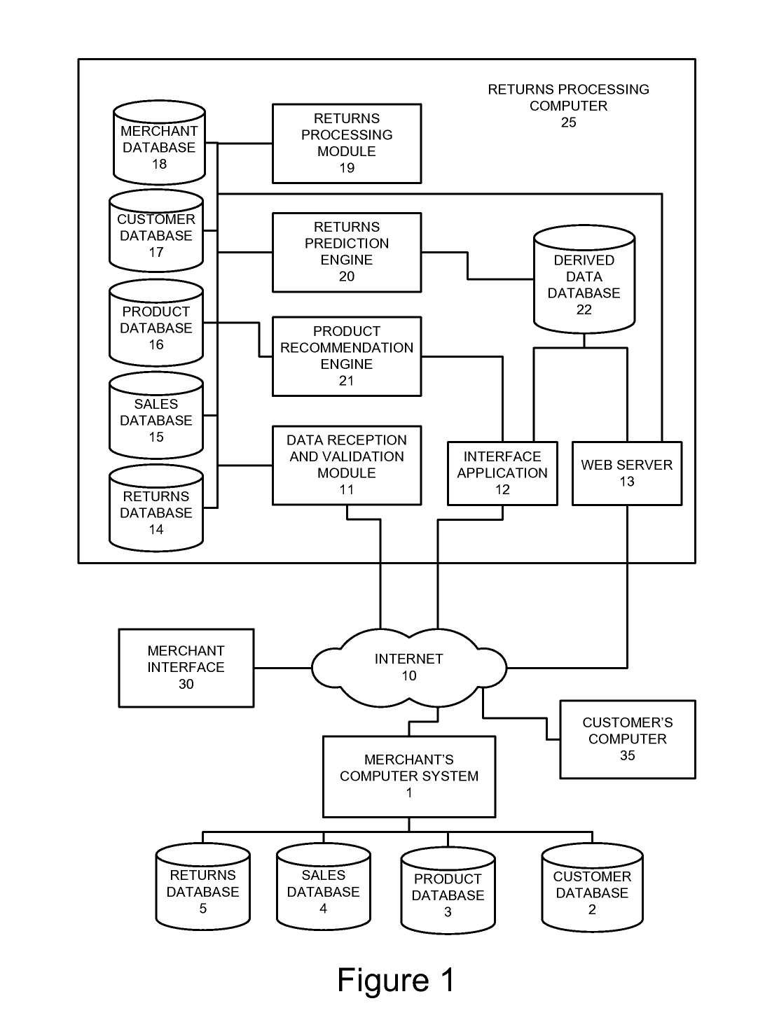

FIG. 1 illustrates an ecommerce system according to one embodiment. A merchant's computer system 1 hosts ecommerce software to provide an ecommerce environment for access by customers using customer's computers 35 over the internet 10. Although the internet is described in this embodiment, any suitable communications network can be used, including wired and wireless networks, a local area network, a wide area network, Bluetooth, Wi-Fi, and a cellular network. The software and hardware to provide such an ecommerce environment is well known and will comprise an application service or a service providing the processing with a web server providing the interface. Databases 2 to 5 are provided for the merchant to store the data. A customers database 2 stores customer data including username, password, account data, and personal data. A product database 3 stores data on the products offered for sale on the ecommerce site hosted by the merchant's computer system 1. The data can include a product ID, description (including name, colour, size etc), photos, price, and stock numbers. A sales database stores data on the sales made by the ecommerce site, such as product IDs, sales prices, volumes, dates, customer IDs, transaction ID, shipping data, tax, payment information etc. A returns database stores data on returned products, such as transaction ID, return reason code (i.e. a reason selected by a customers as to why the product was returned), standardized return codes (i.e. standardized across multiple merchants), date of return, shipping information, value of return, volume of returned products, returned product ID. Although these databases are shown separately in FIG. 1, the databases can be combined in any combination.

Although only one merchant's computer system 1 is illustrated in FIG. 1, many merchant computer systems can be provided connected over the internet 10.

A returns processing computer 25 is connected to the merchant's computer system 1 over the internet. The modules described within the returns processing computer 25 comprise software modules implemented by the returns processing computer 25.

A data reception and validation module 11 is provided connected to the internet for connection to the merchant's computer system 1 to receive uploaded returns related data for products sold by the merchant. The data reception and validation module 11 is connected to a returns database 14, a sales database 15, a product database 16, a customer database 17 and a merchant's database 18. These databases receive the data uploaded by the data reception and validation module 11. Hence, they contain a mirror of the data in databases 2 to 5 to enables the returns processing of the data and the enhancement of the ecommerce service provided by the merchant's computer system 1. These databases need not be provided separately and any suitable database configuration can be used for the data storage.

The product database 16 stores for each product:
1. Product ID in the form of a (stock control unit) SKU
2. Product description eg size, color, name
3. Merchant categories, brand, type
4. Standard product category structure (mapped from the merchant categories
5. Merchant ID
6. Transaction IDs for transactions for the product

The customer database 17 stores for each customer:
1. Customer ID
2. Personal data
3. Purchase history derived from purchase data
4. Return score indicating the customer's propensity to return products
5. Marketing data such as how the customer arrived at the site and what device they used

The sales database stores for each transaction:
1. Transaction ID
2. Product IDs (SKU)
3. Customer ID
4. Sale price
5. Shipping data
6. Order ID—an order can include e transaction IDs
7. Point of sale/location
8. Quantity (volume)
9. Tax
10. Postcode for shipping
11. Date of sale
12. Payment type e.g. credit card, debit card, PayPal
13. Payment information e.g. credit card details, PayPay account details (The payment records may only be stored at the merchant's computer system 1 to reduce security risks of holding payment information centrally)

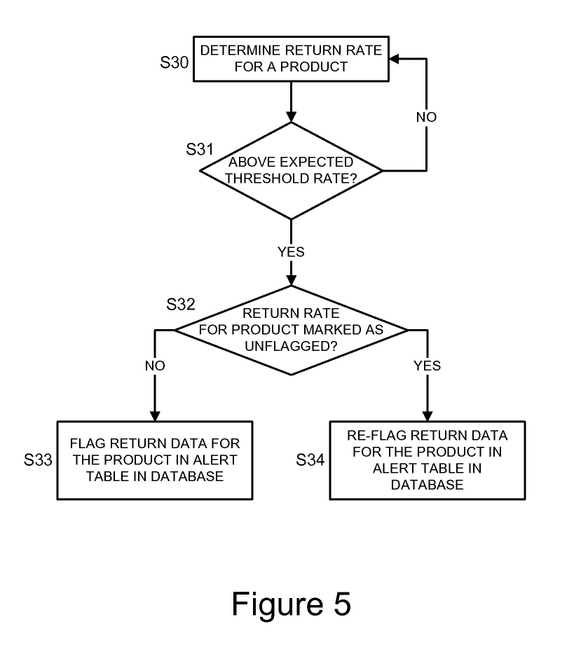

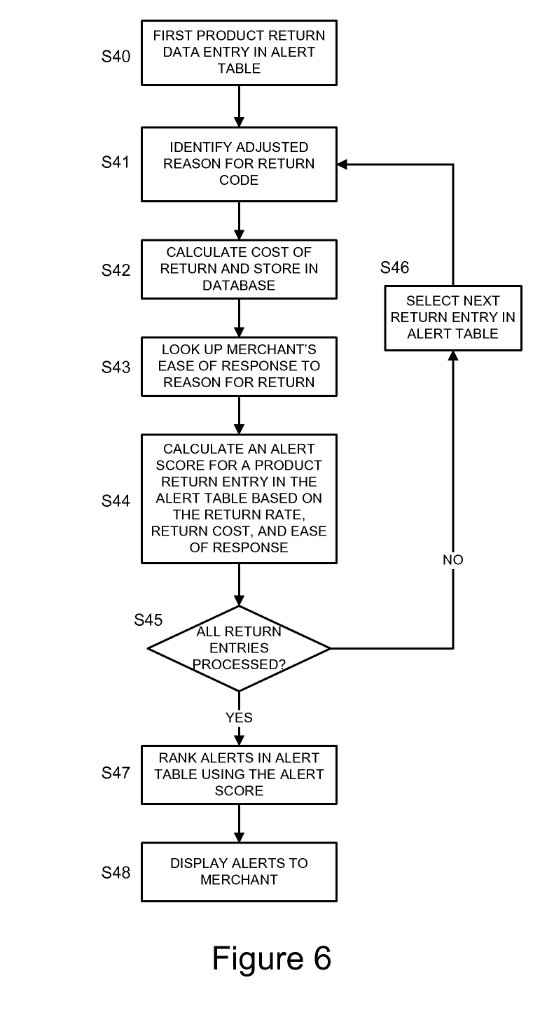

The merchant database 18 stores for each merchant:
1. Merchant ID
2. Product IDs
3. Merchant personal data e.g. address, names etc
4. Alert threshold to be used in the alert process described hereinafter with reference to FIG. 5
5. Ease of response to reasons for return for use in the alert ranking process described hereinafter with reference to FIG. 6
6. Product type return rates—the rates of return (percentage or fraction) of types of products sold by the merchant. A type of product may include multiple products or a specific product. The term product is used hereinafter to refer to a product which is the subject of a transaction and/or return.

The returns database 14 stores data on each return:
1. Return ID
2. Transaction ID
3. Reason code and description
4. Standard reason code
5. Date of return
6. Shipping data
7. Returned product ID
8. Value of return
9. Quantity (volume)

A merchant's interface 30 is provides connected to the internet 10 for connection to the merchant's computer system 1 or to the returns processing computer 25. The merchant's interface can be provided by a computer or other computing capable device such as a mobile telephone, hosting a web client application.

A returns processing module 19 is connected to the databases 14 to 18 to perform processing on the data as will be described in more detail hereinafter. A returns prediction engine 20 is provided connected to the databases 14 to 18 to process data in the databases to generated returns predictions for products as will be described in more detail hereinafter. The returns prediction engine 20 is connected to a derived database 22 in which the derived prediction data is stored.

The derived data in the derived data database 22 includes
1. The predicted returns data
   i. the product IDs
   ii. number of products (volume)
   iii. time periods
   iv. return rate (percentage of products returned or a fraction of products returned)
   v. refund value
   vi. estimated cost to serve the refund
   vii. Future event data—effect of merchant action in response to an alert.
2. Adjusted reasons for return
   i. Reason code
   ii. Product ID
3. Alert table
   i. Product ID
   ii. Alert rankings
   iii. Flag indicator to indicate a live alert

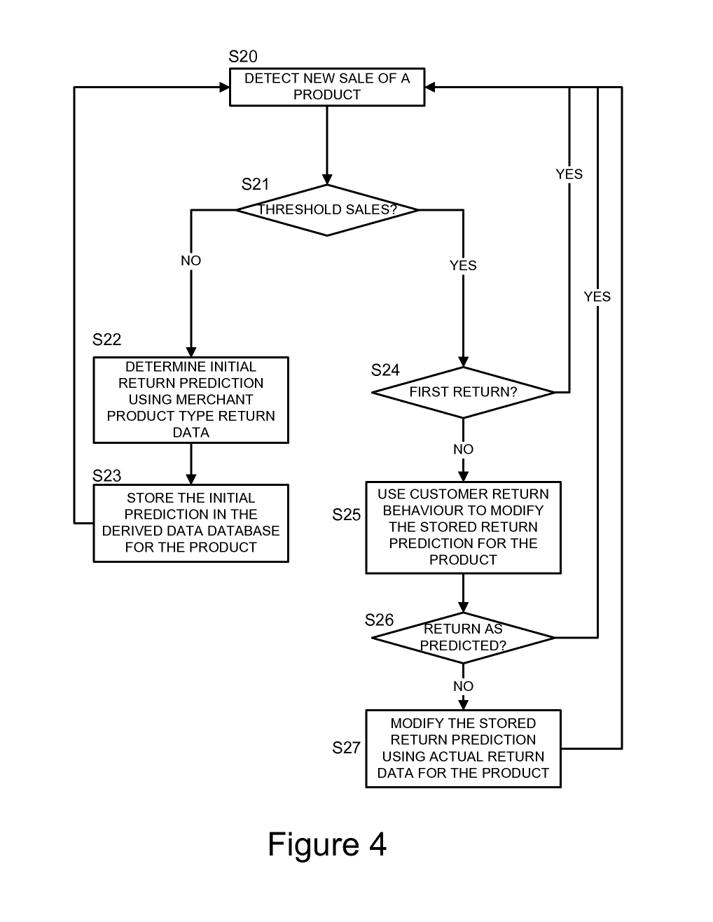

The predicted returns data is the output of the returns prediction process that will be described hereinafter with reference to FIG. 4. The standard reasons for return are mappings of the customer entered reasons for return to a set of reason codes that are standard for all merchants. The alert table is the table used by the alert process described hereinafter with reference to FIG. 5.

A web server 13 is provided connected to all the databases 14 to 18 and 22 to enable reports to be generated and accessible to the merchant interface 30. The reports can be of the raw processed data, the processed data and the derived data (returns predictions and alerts)

A product recommendation engine 21 is provided connected to the databases 14 to 18 to recommend products to the merchant's computer 1. An interface application 12 is provided to enable the merchant's computer system 1 to connect through the interface 12 to the product recommendation engine 21. Although the product recommendation engine is shown in this embodiment in the returns processing computer 25, it can be located in the merchant's computer systems 1.

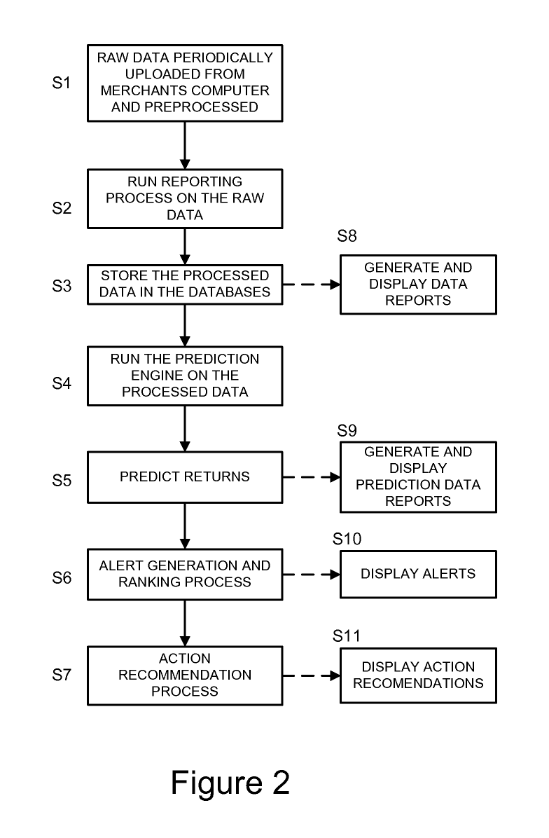

FIG. 2 is a flow diagram of the process in accordance with one embodiment.

In step S1 the raw data is periodically uploaded from the merchant's computer system 1 to the returns processing computer 25 where it is preprocessed and stored in the databases 14 to 18. In step S2 a reporting process is run on the raw data and in step S3 the processed data is stored in the databases 14 to 18. The reporting process generates aggregate data such as total products sold and returned, sales on each date etc. This data enables the web server 13 to generate and display data reports (step S8).

In step S4, the prediction engine 20 runs on the processed data in the databases 14 to 18 to generate predicted returns (step S5), to generate alerts and to rank them (step S6) and to perform the action recommendation process (step S7). These processes will be described in more detail hereinafter. Reports on the prediction data can be generated for display as web pages by the web server 13 (step S9. Alerts can be generated as web pages by the web server 13 for display to merchants using the merchant's interface 30 (step S10). Action recommendations can be generated as web pages by the web server 13 for display to merchants using the merchant's interface 30 (step S11).

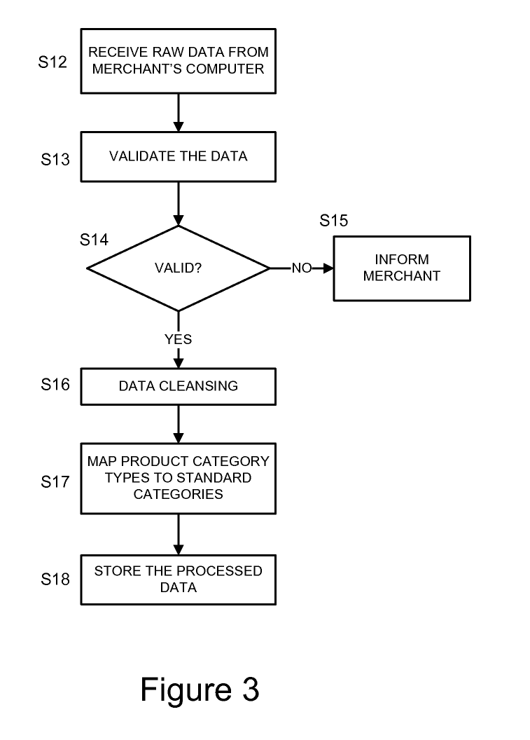

FIG. 3 is a flow diagram of the data acquisition and preprocessing process of step S1 in FIG. 2.

In step S12 the raw data is received from the merchant's computer 1. The data is validated in step S13. This process checks the data for missing fields and to ensure that the format of the data is correct. If the data is not valid (step S14), the merchant is informed (step S15). If the data is valid (step S14), in step S16 the data is cleansed. In this process for example, date formats are standardized, any test data is removed and the data is de-duplicated. In step S17 the merchants product category types are mapped to a standard category structure and is step S18 the processed data is stored in the databases 14 to 18.

The returns prediction process will now be described with reference to FIG. 4.

The data in the databases 14 to 18 is periodically reviewed to identify new sales data for a product that has not been processed (step S20). For the first few sales i.e. threshold=5 sales (steps S21) the process determines an initial returns prediction using the merchant's product type return data (step S22). The initial prediction data is then stored in the derived data database 22 for the product.

Once the threshold level of sales has been reached (step S21), the process determines whether there has been a first return (step S24). If not the process loops back to step S20. If there has been a return from a customer, the customer return score is used to modify the stored return prediction for the product to modify it according to the propensity of the customer to return products (step S25). The process then determines whether the predicted return matches the actual return in step S26. If the prediction matched the actual return, the process loops back to step S20. If the predicted return does not match the actual return, in step S27 the stored return prediction is modified using the actual return data for the product.

Hence using the prediction engine provides a prediction of future returns. This information can be provided to the merchant in a report and it allows the merchant to plan for such returns i.e. ensure they have sufficient staff etc in place.

The process of alerting the merchant to unusually high returns will now be described with reference to FIGS. 5 and 6.

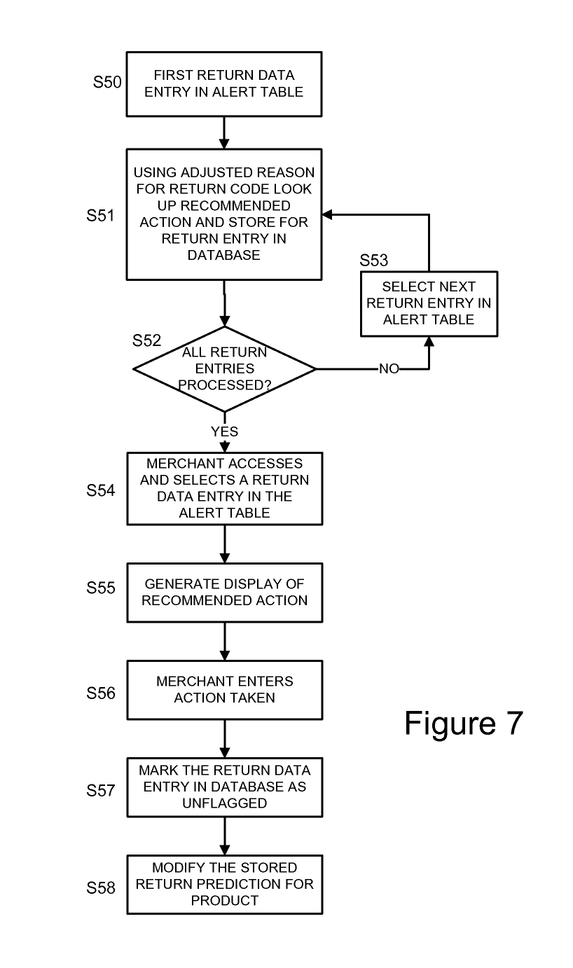

In step S30 a return rate is calculated for a product based on comparing the number of sales to the number of returns and representing the result at a percentage or fraction. The determined rate is compared with a threshold for the merchant (step S31). The threshold can be the same for all products or it can be specific to each product sold by the merchant. If the return rate is below the threshold the process loops back to step S30 to await the next return rate determination. If the return rate is determined to be above the threshold (step S31), it is determined whether the product is marked as “unflagged” (stop S32). If not, the return data for the product is flagged in an alert table in the derived database 22. If the return data is determined to be unflagged (step S32), the return data for the product is re-flagged in the alert table in the derived data database 22. The “unflagged” status is a status than can be set during the response by the merchant to the action recommendation process of FIG. 7. It indicates that the data was previously flagged and then unflagged when the merchant took action. However, the re-flagging of the returns data indicates that the action by the merchant was unsuccessful.

FIG. 6 is a flow diagram of the process for ranking the flagged product returns, storing the ranked data, and generating an output to display it at the merchant's computer system 1 via the web server 13.

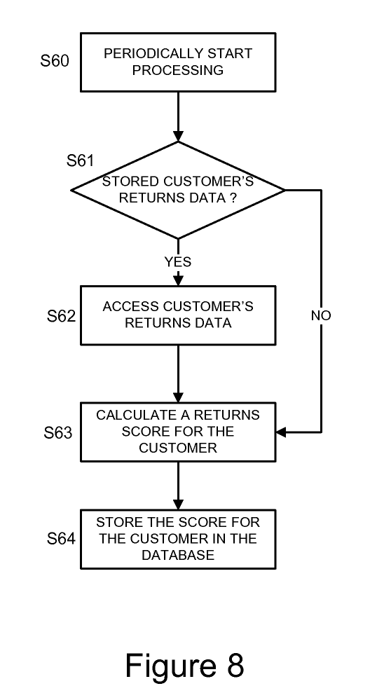

In step S40 the product return data is processed to identify a first product return data entry in the alert table. The code for the adjusted reason for return is then identified (step S41). The code for the reason for return is adjusted by applying a returns score for the customer making the return to the code the customer selected for the reason for returning the product. The return score for a customer is determined based on their return behaviour in the past and is discussed with reference to the flow diagram of FIG. 8 hereinafter. The returns score for the customers is an indicator of the customer's trustworthiness and value to the merchants and hence data from a customer with a low returns score is considered more valid than data from a customer with a high returns score.

In step S42 the cost of the return is calculated and stored in the derived data database 22. The merchant's ease of response to the reason for return is then looked up in the merchant's database (step S43). An alert score for the product return entry in the alert table is then calculated based on the return rate, the cost of the return and the ease of response to the reason for return (step S44). An alert entry in the table with a higher score will be displayed first to the merchant. Hence, if the cost of a return is low and the ease of response is high (east to respond), the alert score for the product will be high because the fix to reduce future returns is easy and low cost. An example of this would be if the reason for the high return rate for a product was an inaccurate description on the ecommerce web page, the cost of fixing it is low and the ease with which it can be fixed is high since it only requires the description to be rewritten and resubmitted to the web site.

In step S45 it is determined whether all entries in the alert table have been processed and if not the next product return entry in the alert table is selected (step S46) and the process loops back to step S46. If it is determined that all entries in the alert table have been processed (step S45), in step S47 the alerts in the alert table are ranked using the alert scores and the alerts are displayed to the merchant using the web server 13.

Thus, the alert process of FIGS. 5 and 6 provides a means of warning merchants when the rate of returns for a product becomes unusually high.

A method of taking action to try to improve future return rates will now be described with reference to FIG. 7.

In step S50, the product return data is processed to identify a first product return data entry in the alert table. The code for the adjusted reason for return is then used to look up recommended action (step S51). In step S52, it is determined whether all entries in the alert table have been processed and if not the next product return entry in the alert table is selected (step S53) and the process loops back to step S51. If it is determined that all entries in the alert table have been processed (step S52), in step S54 the merchant accesses and selects a return data entry in the alert table using the merchant interface 30 and the web server 13. The process then generates a display of recommended actions to reduce the likelihood of product returns for the same reasons in the future (step S55). The merchant can act upon this and take the suggested action, whereupon the merchant enters information on the action taken (step S56) and this is entered in the database and to return data entry in the alert table is unflagged (step S57) to indicate that the merchant has taken action and the stored product returns prediction is modified to take into account the action taken by the merchant. FIG. 8 is a flow diagram illustrating the process for determining a score for a customer, which reflects the customer's propensity to return products. Merchants can use the score in a like manner to a credit score when considering their relationship with the customer.

In step S60 of FIG. 8, periodically the process implements. If customer's returns data is already stored for the customer (step S61), the customer's returns data is accessed (step S62) and the returns score calculated for the customer by modifying the stored customer's returns data (step S63). If customer's returns data is not stored for the customer (step S61) (indicating that the customer has not made any returns yet), the returns score is calculated for the customer (step S63). The returns score is calculate by comparing the returns data with the sales data for the customer to determine, a propensity to return products. The propensity to return products can, for example be identified by comparing the ratio of products returned to products purchased. The score can also for example be influenced significantly negatively by multiple returns of the same product, unless the product was faulty. Hence, the returns score in one embodiment is not simply a rate of return, but a more complex indication of the return behaviour of a customer. If a customer has not made any returns, but has made many purchases, their returns score will be very low. A customer who has made just a few returns but has made at least some of these returns multiple time will get a higher returns score than a customer with a higher number of returns involving just single instances of product returns. In step S64, the returns score for the customer is stored in the customer database for use.

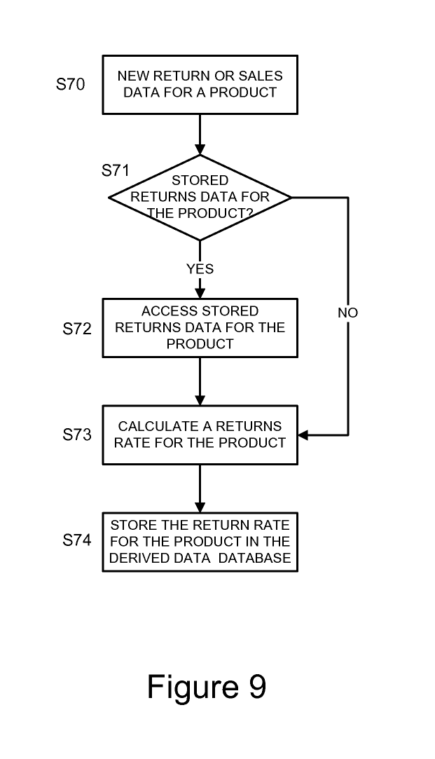

FIG. 9 is a flow diagram illustrating the process for the determination of the product return rate.

In step S70 of FIG. 9, new returns or sales data for a product is periodically processed. If product's returns data is already stored for the customer (step S71), the product's returns data is accessed (step S72) and the returns rate calculated for the product by modifying the stored product's returns data (step S73). If customer's returns data is not stored for the customer (step S71), the returns rate is calculated for the product (step S73). The returns rate for a product is calculated by comparing the returns data with the sales data for the product to determine a propensity for the product to be returned. The propensity for the product to be returned can, for example be identified by comparing the ratio of the number of returns for the product by customers to the number of products purchased by customers. The return rate for the product is then stored in the derived data database (step S74).

So far the process has been described with reference only to processing returns data for products to provide predictive information on returns and to assist merchants reduce returns. Embodiments will now be described which use product returns data and a customer's returns score to modify the customer's interface at the merchant's computer to assist the merchant in managing and reducing returns at the point of purchase or to convert returns into product exchanges.

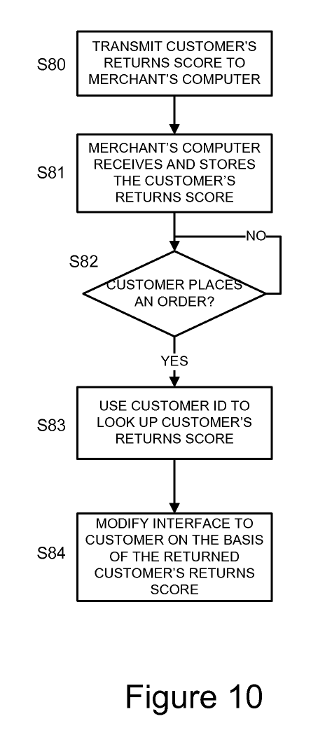

FIG. 10 is a flow diagram illustrating a process to use a customer's returns score to modify the customer's interface.

In step S80 a customer's returns score is transmitted to the merchant's computer system 1 and in step S81 the merchant's computer system receives and stores the customer's returns score. The process then waits for the customer to place an order (step S82), whereupon the customer's ID is used to look up the customer's returns score (step S83). In step S84 the interface to the customer is generated or modified on the basis of the returned customer's returns score.

Hence, in this embodiment, the customer's interface is customized based on their returns behaviour. In an extreme case, if the customer has abused the returns system in the past by making fraudulent returns claims or by making repeated returns claims, the customer's interface may be customized for them to omit the ability to make a return. Even at the point of sale, the terms and conditions presented to the customer could state that the customer cannot return the products.

In another embodiment, the personalization of the interface might only take place when the customer selects a product. In this case, the returns data for the product type or product can be used to personalize the interface for the customer for the specific instance of purchasing the product.

Another embodiment will now be described which relates to a method for trying to convert refund requests into exchanges for other products from the same merchant. This has the benefit to the merchant or saving a sale even if the return of the product first purchased cannot be avoided.

In step S90, a customer selects to return a product on the merchant's ecommerce site on the merchant's computer system 1 and customer entered data is received, which includes product data or ID and a return code and description (step S91). Based on the entered data, the merchant's computer identifies a product from the entered data (step S92). The merchant's computer then looks up the customer's return score by requesting it from the derived data database 22 via the interface application 12 of the returns processing computer 25 (step S93). The merchant's computer is able to receive the customer's returns score and use this to determine whether the customer is eligible for an exchange (step S94). If it is determined that the customer is not eligible for an exchange, a returns interface is generated for the customer (step S95), returns data is received for the product from the customer (step S96), and the return is processed (step S97).

If it is determined that the customer is eligible for an exchange (step S94), the merchant's computer generates an interface to asking the customer if they would like the same product but in a different size or color (step S98). If the customer selects a different size or color, the merchant's computer generates an interface to offer the product in the new size or color (step S99) and the step S100 the transaction for the exchange product is completed. The transaction for the exchanged product will be linked in the database with the transaction for the original product.

If the customer does not select to want the same product in step S98, the merchant's computer identifies and outputs options for similar products on an interface (step S101) and waits for the customer to select a similar product or not (step S102). If the customer does not select a similar product as an exchange for the returned product, the process returns to step S95 to generate a returns interface for the customer (step S95), to receive returns data for the product from the customer (step S96), and to process the return (step S97).

If the customer does select a similar product as an exchange for the returned product (step S102), the merchant computer completes the transaction of the similar product, stores the transaction data and a link between the transaction and the transaction of the returned product (step S103).

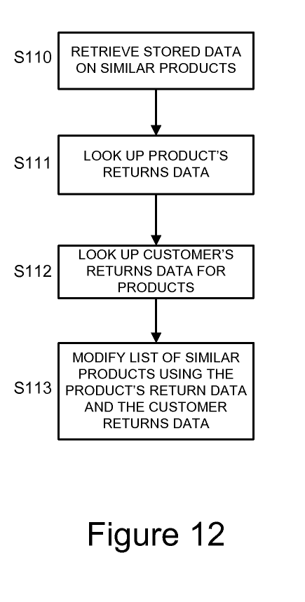

FIG. 12 is a flow diagram illustrating the process for determining similar products. The process is carried out by the product recommendation engine 21, which can be provided at the returns processing computer 25 or the merchant's computer system 1.

In step S110 data on similar good is looked up based on the product ID for a product. Data identifying similar products can be stored in the product database 16. The product returns data is then looked up in the returns database for the product (step S111) and customer returns data for the product is looked up in the returns database (step S112). The list of similar products is then modified using the products return data and the customer returns data for the product (step S113).

This process uses the product's return data, which includes returns data for other customers and can comprise a rate of return of the product for example as well as a more focused product return relating specifically to the customer. If the rate of return of a product is high, then it will be weighted less of negatively to push it down the list. If the product has a low rate of return, but the customer return data for the product indicates that the customer has returned the product previously, the product will still be weighted less of negatively to push it down the list.

The provision of the customer's returns score to the merchant enables the merchant to personalize the customer's interface to the ecommerce system based on their returns behaviour. In an extreme case where a customer has behaved fraudulently and their returns score is very high, a merchant's computer may be configured to prevent the customer from carrying out a transaction for a product. This can be achieved by presenting to the customer that the product is out of stock to avoid notifying the customer that the merchant does not want to transact with them. Alternatively, where the customer returns score is less high, a customer may simply be informed that refunds are not available, or that an exchange only is available. In another embodiment, the merchant may use the return score for customers to calculate a discount or to make other offers. The merchant is able to understand the risk of a return from the customer. In this way the terms of doing business with the customer are altered dependent upon the returns behaviour of the customer.

With regard to the exchange processing, the merchant can apply internal factors as well as the customer return score and the product return rate, in the determination of the exchange offer. For example, the distance from the supply depot to the customer can be taken into consideration as a delivery cost and an environmental factor. Also, product stock factors can be used in the determination of the products to offer in exchange. For example, the merchant may have a lot of stock of a product that they would like to sell and hence when determining the products to offer as exchange options, such a high stock product is given a higher weighting in the determination. Other internal factors that can be used in the determination of the similar products to offer in exchange are profit margins on products (high profit margin products can be given a higher weighting), or products with a shelf life (for example fashion items that need to be sold during the season).

The following is a description of some generalized embodiments. Any embodiment can be used in combination with any other embodiment.

One aspect provides a computer implemented method of processing data on returned products, the method comprising receiving returns data on purchased products returned for a refund; and determining predicted return data for a product sold in the future based on the returns data for the product purchased in the past.

In one embodiment, the predicted return data comprises a predicted return rate from a comparison of the number of sales of the product to the number of returns of the product.

In one embodiment, before returns data for the product is available, the predicted return data is determined based on return data for a product type, the product belonging to the product type.

In one embodiment, the predicted return data is modified dependent upon data on customer return behaviour for customers of the product.

In one embodiment, the method includes receiving further returns data on the purchased products returned for a refund after a determination of the predicted return data for the product, wherein the predicted return data is modified dependent upon the further returns data.

Another aspect provides a computer system for processing data on returned products, the system comprising a program memory storing program code; and a processor for implementing the program code stored in the program memory; wherein the program code comprises code for controlling the processor to receive returns data on purchased products returned for a refund; and code for controlling the processor to determine predicted return data for a product sold in the future based on the returns data for the product purchased in the past.

In one embodiment, the predicted return data comprises a predicted return rate from a comparison of the number of sales of the product to the number of returns of the product.

In one embodiment, the code for controlling the processor includes code for controlling the processor to, before returns data for the product is available, determine the predicted return data based on return data for a product type, the product belonging to the product type.

In one embodiment, the code for controlling the processor includes code for controlling the processor to modify the predicted return data dependent upon data on customer return behaviour for customers of the product.

In one embodiment, the code for controlling the processor includes code for controlling the processor to receive further returns data on the purchased products returned for a refund after a determination of the predicted return data for the product, and code for controlling the processor to modify the predicted return data dependent upon the further returns data.

Another aspect provides a computer implemented method of processing data on returned products, the method comprising receiving returns data on purchased products returned for a refund; comparing the returns data with reference returns data for the products; and generating an alert for a merchant of a product when the result of the comparison indicates a difference above a threshold difference.

In one embodiment, the returns data includes data indicative of at least one of a volume and a value of the returned products, the reference data includes data indicative of at least one of a reference volume and a reference value of the returned products, and the alert is generated when at least one of the volume of the returned products is greater than the reference volume of the returned products, and the value of the returned products is greater than the reference value of the returned products.

In one embodiment, said alert is generated for each of a plurality of products for the merchant, and the returns data includes data on the reasons for the return of the product, the method including ranking each alert dependent upon at least one of data on the ease with which the merchant could address the reason for the return of the product indicated in the returns data, and a cost associated with the return of the product.

In one embodiment, the returns data includes data on the reasons for the return of the product, the method including determining recommended action to be taken by the merchant to reduce future returns for a product based on the data on the reason for return of the products.

Another aspect provides a computer system for processing data on returned products, the system comprising a program memory storing program code; and a processor for implementing the program code stored in the program memory; wherein the program code comprises: code for controlling the processor to receive returns data on purchased products returned for a refund; code for controlling the processor to compare the returns data with reference returns data for the products; and code for controlling the processor to generate an alert for a merchant of a product when the result of the comparison indicates a difference above a threshold difference.

In one embodiment, the returns data includes data indicative of at least one of a volume and a value of the returned products, the reference data includes data indicative of at least one of a reference volume and a reference value of the returned products, and the code for controlling the processor includes code for controlling the processor to generate the alert when at least one of the volume of the returned products is greater than the reference volume of the returned products, and the value of the returned products is greater than the reference value of the returned products.

In one embodiment, the code for controlling the processor includes code for controlling the processor to generate said alert for each of a plurality of products for the merchant, the returns data includes data on the reasons for the return of the product, and the code for controlling the processor includes code for controlling the processor to rank each alert dependent upon at least one of data on the ease with which the merchant could address the reason for the return of the product indicated in the returns data, and a cost associated with the return of the product.

In one embodiment, the returns data includes data on the reasons for the return of the product, the code for controlling the processor includes code for controlling the processor to determine recommended action to be taken by the merchant to reduce future returns for a product based on the data on the reason for return of the products.

Another aspect provides a computer implemented method of processing data on returned products, the method comprising receiving returns data on purchased products returned for a refund, the returns data includes data on the reasons for the return of the product; determining recommended action to be taken by the merchant to reduce future returns for a product based on the data on the reason for return of the products; and generating an output of the recommended action for display to the merchant.

In one embodiment, the method includes receiving data on the action taken by the merchant, receiving further said returns data for products returned after the action taken by the merchant, comparing the returns data for products returned before and after the action taken by the merchant, and generating an output to the merchant indicative of the comparison.

Another aspect provides a computer system for processing data on returned products, the system comprising a program memory storing program code; and a processor for implementing the program code stored in the program memory; wherein the program code comprises code for controlling the processor to receive returns data on purchased products returned for a refund, the returns data includes data on the reasons for the return of the product; code for controlling the processor to determine recommended action to be taken by the merchant to reduce future returns for a product based on the data on the reason for return of the products; and code for controlling the processor to generate an output of the recommended action for display to the merchant.

In one embodiment, the method includes code for controlling the processor to receive data on the action taken by the merchant, code for controlling the processor to receive further said returns data for products returned after the action taken by the merchant, code for controlling the processor to compare the returns data for products returned before and after the action taken by the merchant, and code for controlling the processor to generate an output to the merchant indicative of the comparison.

Another aspect provides a computer implemented method comprising receiving customer selection data for a product that the customer proposes to one of purchase and refund, the customer selection data including data identifying the customer and the product; accessing returns data using at least one of the data identifying the customer and the data identifying the product, the returns data indicating at least one of a customer's propensity to return products and a propensity of the product to be returned; and generating a customer interface dependent upon on the returns data for one of the proposed purchase and the proposed refund.

In one embodiment, the customer interface is generated to at least one of change commercial terms on the which the proposed purchase is to proceed, to prevent the customer from completing the proposed purchase, and to prevent the customer from completing the proposed refund.

In one embodiment, the customer interface is generated to offer the customer an opportunity to exchange the product instead of the proposed refund.

Another aspect provides a computer system comprising a program memory storing program code; and a processor for implementing the program code stored in the program memory; wherein the program code comprises: code for controlling the processor to receive customer selection data for a product that the customer proposes to one of purchase and refund, the customer selection data including data identifying the customer and the product; code for controlling the processor to access returns data using at least one of the data identifying the customer and the data identifying the product, the returns data indicating at least one of a customer's propensity to return products and a propensity of the product to be returned; and code for controlling the processor to generate a customer interface dependent upon on the returns data for one of the proposed purchase and the proposed refund.

In one embodiment, the code for controlling the processor comprises code for controlling the processor to generate the customer interface to at least one of change commercial terms on the which the proposed purchase is to proceed, to prevent the customer from completing the proposed purchase, and to prevent the customer from completing the proposed refund.

In one embodiment, the code for controlling the processor comprises code for controlling the processor to generate the customer interface to offer the customer an opportunity to exchange the product instead of the proposed refund.

Another aspect provides a computer implemented ecommerce method comprising receiving customer selection data for a product that the customer proposes to refund, the customer selection data including data identifying the product; accessing returns data using the data identifying the product, the returns data indicating a propensity of the product to be returned; identifying alternative products using the returns data for the product and returns data for the alternative products; and generating exchange data identifying the alternative products to be offered to the customer in exchange for the product.

Another aspect provides an ecommerce system comprising a program memory storing program code; and a processor for implementing the program code stored in the program memory; wherein the program code comprises: code for controlling the processor to receive customer selection data for a product that the customer proposes to refund, the customer selection data including data identifying the product; code for controlling the processor to access returns data using the data identifying the product, the returns data indicating a propensity of the product to be returned; code for controlling the processor to identify alternative products using the returns data for the product and returns data for the alternative products; and code for controlling the processor to generate exchange data identifying the alternative products to be offered to the customer in exchange for the product.

Another aspect provides a carrier medium such as a non-transient storage medium storing computer code for controlling a computer to carry out the method, or a transient medium carrying computer readable code for controlling a computer to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (Compact disc (CD) or digital versatile disc (DVD)).

Although the embodiments have been described with reference to a customer's computer, the invention covers the use of any computing devices by a customer. For example, the computer used by customers can be any device capable of connecting over a network to the merchant's computer, such as mobile devices e.g. smart phones, tablet computers, laptop computers, which can connect over a wireless network such as Wi-Fi, Bluetooth or a wireless cellular network.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A computer system for processing data on returned products, the system comprising:
a program memory storing program code; and
a processor for implementing the program code stored in the program memory;
wherein the program code comprises:
code for controlling the processor to receive returns data on purchased products returned for a refund; and
code for controlling the processor to determine predicted return data for a product sold in the future based on the returns data for the product purchased in the past.

2. A system according to claim 1, wherein the predicted return data comprises a predicted return rate from a comparison of the number of sales of the product to the number of returns of the product.

3. A system according to claim 1, wherein the code for controlling the processor includes code for controlling the processor to, before returns data for the product is available, determine the predicted return data based on return data for a product type, the product belonging to the product type.

4. A system according to claim 1, wherein the code for controlling the processor includes code for controlling the processor to modify the predicted return data dependent upon data on customer return behaviour for customers of the product.

5. A system according to claim 1, wherein the code for controlling the processor includes code for controlling the processor to receive further returns data on the purchased products returned for a refund after a determination of the predicted return data for the product, and code for controlling the processor to modify the predicted return data dependent upon the further returns data.

6. A computer system for processing data on returned products, the system comprising:
a program memory storing program code; and
a processor for implementing the program code stored in the program memory;
wherein the program code comprises:
code for controlling the processor to receive returns data on purchased products returned for a refund;
code for controlling the processor to compare the returns data with reference returns data for the products; and
code for controlling the processor to generate an alert for a merchant of a product when the result of the comparison indicates a difference above a threshold difference.

7. A system according to claim 6, wherein the returns data includes data indicative of at least one of a volume and a value of the returned products, the reference data includes data indicative of at least one of a reference volume and a reference value of the returned products, and the code for controlling the processor includes code for controlling the processor to generate the alert when at least one of the volume of the returned products is greater than the reference volume of the returned products, and the value of the returned products is greater than the reference value of the returned products.

8. A system according to claim 6, wherein the code for controlling the processor includes code for controlling the processor to generate said alert for each of a plurality of products for the merchant, the returns data includes data on the reasons for the return of the product, and the code for controlling the processor includes code for controlling the processor to rank each alert dependent upon at least one of data on the ease with which the merchant could address the reason for the return of the product indicated in the returns data, and a cost associated with the return of the product.

9. A system according to claim 6, wherein the returns data includes data on the reasons for the return of the product, the code for controlling the processor includes code for controlling the processor to determine recommended action to be taken by the merchant to reduce future returns for a product based on the data on the reason for return of the products.

10. A computer system for processing data on returned products, the system comprising:
a program memory storing program code; and
a processor for implementing the program code stored in the program memory;
wherein the program code comprises:
code for controlling the processor to receive returns data on purchased products returned for a refund, the returns data includes data on the reasons for the return of the product;
code for controlling the processor to determine recommended action to be taken by the merchant to reduce future returns for a product based on the data on the reason for return of the products; and
code for controlling the processor to generate an output of the recommended action for display to the merchant.

11. A system according to claim 10, including code for controlling the processor to receive data on the action taken by the merchant, code for controlling the processor to receive further said returns data for products returned after the action taken by the merchant, code for controlling the processor to compare the returns data for products returned before and after the action taken by the merchant, and code for controlling the processor to generate an output to the merchant indicative of the comparison.

12. A computer system comprising:
a program memory storing program code; and
a processor for implementing the program code stored in the program memory;
wherein the program code comprises:
code for controlling the processor to receive customer selection data for a product that the customer proposes to one of purchase and refund, the customer selection data including data identifying the customer and the product;
code for controlling the processor to access returns data using at least one of the data identifying the customer and the data identifying the product, the returns data indicating at least one of a customer's propensity to return products and a propensity of the product to be returned; and
code for controlling the processor to generate a customer interface dependent upon on the returns data for one of the proposed purchase and the proposed refund.

13. A system according to claim 12, wherein the code for controlling the processor comprises code for controlling the processor to generate the customer interface to at least one of change commercial terms on the which the proposed purchase is to proceed, to prevent the customer from completing the proposed purchase, and to prevent the customer from completing the proposed refund.

14. A system according to claim 12, wherein the code for controlling the processor comprises code for controlling the processor to generate the customer interface to offer the customer an opportunity to exchange the product instead of the proposed refund.

15. An ecommerce system comprising:
a program memory storing program code; and
a processor for implementing the program code stored in the program memory;
wherein the program code comprises:
code for controlling the processor to receive customer selection data for a product that the customer proposes to refund, the customer selection data including data identifying the product;
code for controlling the processor to access returns data using the data identifying the product, the returns data indicating a propensity of the product to be returned;
code for controlling the processor to identify alternative products using the returns data for the product and returns data for the alternative products; and
code for controlling the processor to generate exchange data identifying the alternative products to be offered to the customer in exchange for the product.
